(19) United States
(12) Patent Application Publication
(10) Pub. No.: US 2014/0019334 A1
(43) Pub. Date: Jan. 16, 2014

(54) Method to Facilitate Credit and Savings

(71) Applicant: Luis Antonio Cervera, Phoenix, AZ (US)

(72) Inventor: Luis Antonio Cervera, Phoenix, AZ (US)

(21) Appl. No.: 14/031,994

(22) Filed: Sep. 19, 2013

Related U.S. Application Data
(63) Continuation-in-part of application No. 12/798,528, filed on Apr. 6, 2010, now abandoned.
(60) Provisional application No. 61/212,107, filed on Apr. 7, 2009.

(51) Int. Cl. G06Q 40/02

(52) U.S. Cl. CPC G06Q 40/025
USPC 705/38

(57) ABSTRACT

A method to facilitate credit and savings, where that method includes establishing a group setting, establishing an administrator for the group setting, and establishing variables for the group setting, wherein the variables include a risk ranking standard and a number (N) of participants, where (N) is greater than 3 and the risk ranking comprises a credit rating determined by a credit bureau.

### CROSS-REFERENCE TO RELATED APPLICATIONS

This application is a Continuation In Part of United States Non-Provisional Application having Ser. No. 12/798,528 filed Apr. 6, 2010, which claims priority to U.S. Provisional Application No. 61/212,107, filed Apr. 7, 2009, and which are hereby incorporated herein by reference in its entirety.

### FIELD OF INVENTION

The invention relates generally to microfinance and a social network. The proposed invention provides a method of facilitating credit and savings as a rotating credit and savings association over an online network by use of microprocessor based machines.

### BACKGROUND OF INVENTION

With its roots found around the world, the Rotating Savings and Credit Association (ROSCA) is regularly used by millions in private group settings as a means of mobilizing credit and savings at the grassroots level. This method has been in use in private groups for centuries and its widespread use and success can be attributed to the great benefits it provides its participants. ROSCAs are a nontraditional means for its participants to acquire assets through the power of cooperation.

While traditional ROSCAs offer many benefits for its users, there are several inherent limitations which limit its use and scalability. The instant invention removes the limitations of the traditional ROSCAs, thus introducing many great improvements to the traditional model as well as scalability into the system.

### SUMMARY OF THE INVENTION

A method and apparatus are described for establishing and administering a money pool over an online network through the use of microprocessor based machines. Prior art rotating savings and credit method have several key limitations which inhibit the ability to be offered commercially.

Two key disadvantages to such prior art methods are a lack of trust between its participants and an inefficient infrastructure. Applicant's method overcomes both of these shortcomings by streamlining the entire process over an online network; increasing its ease of use as well as allowing participants from distinct geographical locations to participate together. A proprietary risk rating algorithm creates a standard of trust among users.

In addition, Applicant's method improves upon the traditional method by employing important services such as credit reporting of all transactions which will help participants use the proposed invention for the improvement of credit scores.

### BRIEF DESCRIPTION OF THE DRAWINGS

FIG. 1 illustrates a portion of Applicants MoneyPool network which utilizes Applicant's MoneyPool algorithm to administer Applicant's method;

FIG. 2 illustrates certain data storage portions of Applicant's MoneyPool network;

FIG. 3 summarizes certain initial steps of Applicant's method;

FIG. 4 summarizes certain additional steps of Applicant's method;

FIG. 5 summarizes certain additional steps of Applicant's method;

FIG. 6 summarizes certain additional steps of Applicant's method; and

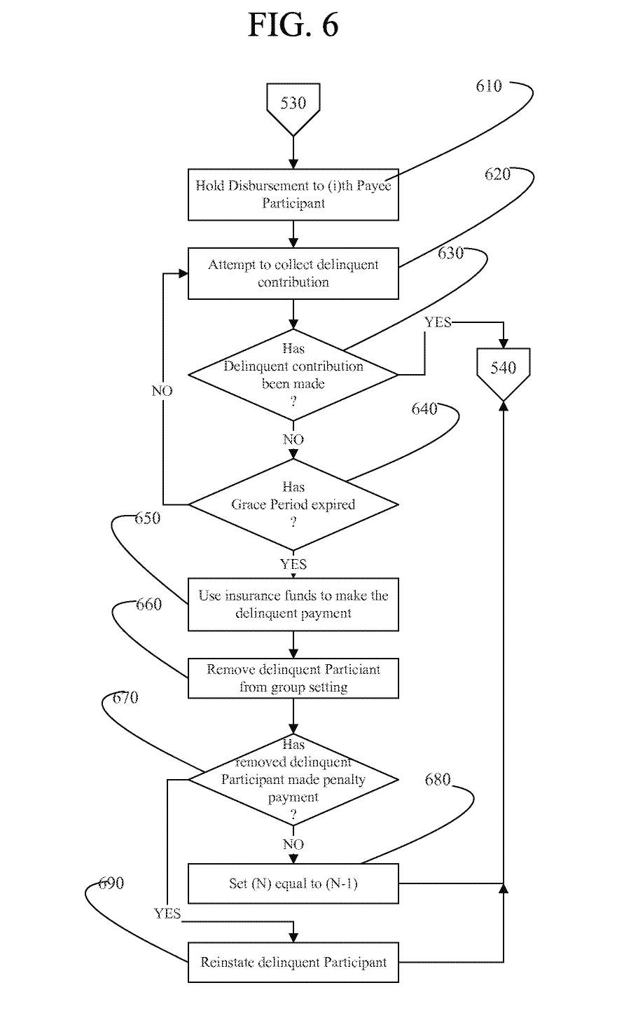

FIG. 7 summarizes certain final steps of Applicant's method.

### DETAILED DESCRIPTION OF THE PREFERRED EMBODIMENT

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

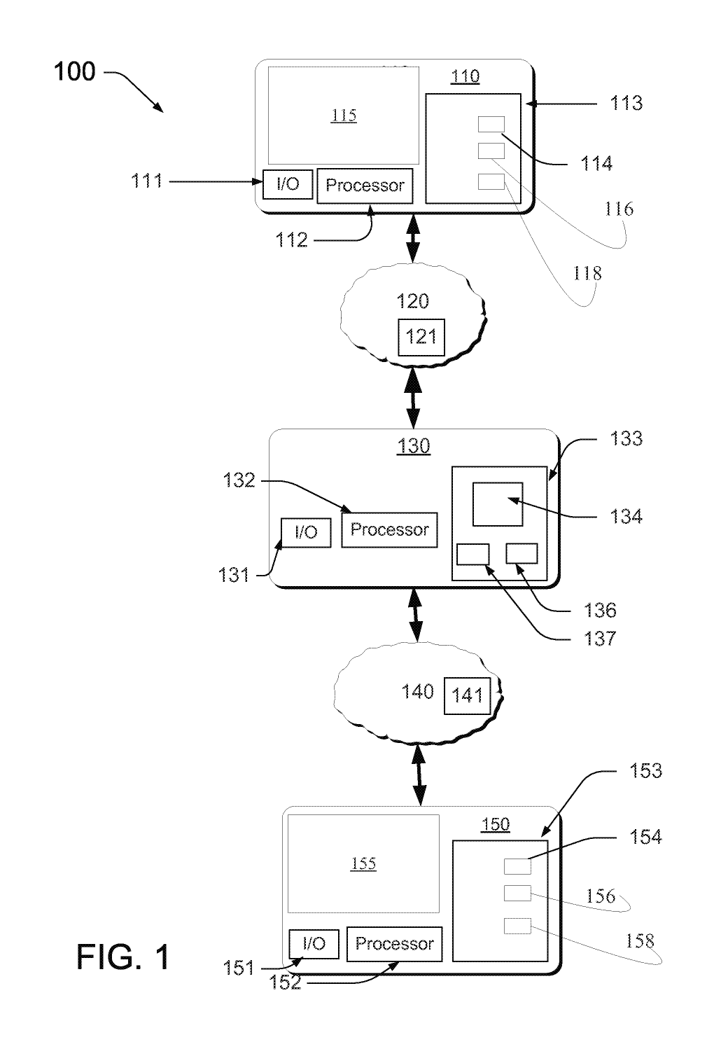

Referring to FIG. 1, a portion of Applicant's MoneyPool Network 100 is illustrated. In certain embodiments, Applicant's MoneyPool Network 100 comprises Applicant's MoneyPool algorithm 136. In certain embodiments, a MoneyPool administer uses a computing device to provide information to Applicant's MoneyPool algorithm 136. In certain embodiments, a MoneyPool participant uses a computing device to provide information to Applicant's MoneyPool algorithm 136.

In either event, Applicant's MoneyPool algorithm 136 then writes that information to, for example and without limitation, a logical volume configured on a data storage device in communication with Applicant's MoneyPool algorithm 136.

As a general matter, Applicant's MoneyPool server 130 and computing devices 110 and 150 each are independently selected from the group consisting of a mainframe computer, a personal computer, a workstation, a mobile telephone, a smart telephone, a personal digital assistant, a laptop, a set-top box, an MP3 player, an email enabled device, a tablet computer, a web enabled device, or other special purpose computer each having one or more processors.

In certain embodiments, a computing device 110 is owned and/or operated by a participating MoneyPool administer. In certain embodiments, a computing device 150 is owned and/or operated by a MONEYPOOL participant (“MoneyPool Participant”).

For the sake of clarity, FIG. 1 shows computing devices 110 and 150 in communication with Applicant's MoneyPool server 130. FIG. 1 should not be taken as limiting. Rather, in other embodiments a plurality of MoneyPool Participants are in communication with Applicant's MoneyPool server 130.

A MoneyPool Participant is not limited to a single computing device to access Applicant's transportation industry management server 130. Quite to the contrary, any number of computing devices can utilize Applicant's API in combination with a unique MoneyPool Access Code to access Applicant's MoneyPool algorithm 136 via MoneyPool server 130. As a result, Applicant's system offers seamless mobile and desktop use for both MoneyPool Participants and MoneyPool administrators.

Furthermore, for the sake of clarity, FIG. 1 shows a single Applicant's MoneyPool server 130. In other embodiments, Applicant's MoneyPool Network 100 comprises a plurality of MoneyPool server 130 disposed in a plurality of locations across the United States.

Participating MoneyPool Participants can access Applicant's MoneyPool server 130 by using, among other devices, a mobile telephone. As a result, the functionality of Applicant's MoneyPool algorithm 136 is available “24/7/365” for MoneyPool administrators and MoneyPool Participants.

As illustrated in FIG. 1, the communication fabrics 120 and 140 each comprise one or more switches 121 and 141, respectively. In certain embodiments, communication fabrics 120 and 140 are the same. In certain embodiments, at least one of the communication fabrics 120 and 140 comprises the Internet, an intranet, an extranet, a storage area network (SAN), a wide area network (WAN), a local area network (LAN), a virtual private network, a satellite communications network, an interactive television network, or any combination of the foregoing. In certain embodiments, at least one of the communication fabrics 120 and 140 utilizes either or both wired or wireless connections for the transmission of signals including electrical connections, magnetic connections, or a combination thereof. Examples of these types of connections include: radio frequency connections, optical connections, telephone links, a Digital Subscriber Line, or a cable link. Moreover, communication fabrics 120 and 140 utilize any of a variety of communication protocols, such as Transmission Control Protocol/Internet Protocol (TCP/IP), for example.

By way of illustration and not limitation, FIG. 1 illustrates computing device 110, Applicant's MoneyPool server 130, and computing device 150 as each comprising a processor 112, 132, and 152, respectively, a non-transitory computer readable medium 113, 133, and 153, respectively, having computer readable program code 114, 134, and 154, respectively, encoded therein; an input/output means 111, 131, and 151, respectively, such as a keyboard, a mouse, a stylus, touch screen, a camera, a scanner, or a printer. Processors 112, 132, and 152, respectively utilize computer readable program code 114, 134, and 154, respectively, to operate computing devices 110, 130, and 150, respectively.

Processors 112 and 152 access Application Program Interfaces (APIs) 116 and 156, respectively, encoded in computer readable media 113 and 153, respectively, to communicate with Applicant's MoneyPool server 130. In certain embodiments, unique identifiers 118 and 158, respectively are encoded in computer readable media 113 and 153, respectively.

In certain embodiments, the unique identifiers 118 and 158 each comprise a unique MoneyPool Access Code. In certain embodiments, Applicant's MoneyPool algorithm 136 associates a user's Access Code with a specific IP address.

In certain embodiments, when API 114/154 establishes communication between computing device 110/150 and Applicant's MoneyPool server 130, MONEYPOOL algorithm 136 causes a graphic user interface (“GUI”) to be displayed on display screen 115/155, wherein that GUI comprises and displays a plurality of graphical interactable objects. A MoneyPool Participant, using computing device 110/150, can utilize that GUI to provide information to Applicant's MONEYPOOL server 130.

In certain embodiments, Applicant's MoneyPool server 130 establishes communication with computing device 110/150 causing a graphic user interface (“GUI”) to be displayed on display screen 115/155. Applicant's MoneyPool server 130 can then display or audibly recite information on that specific computing device 110/150.

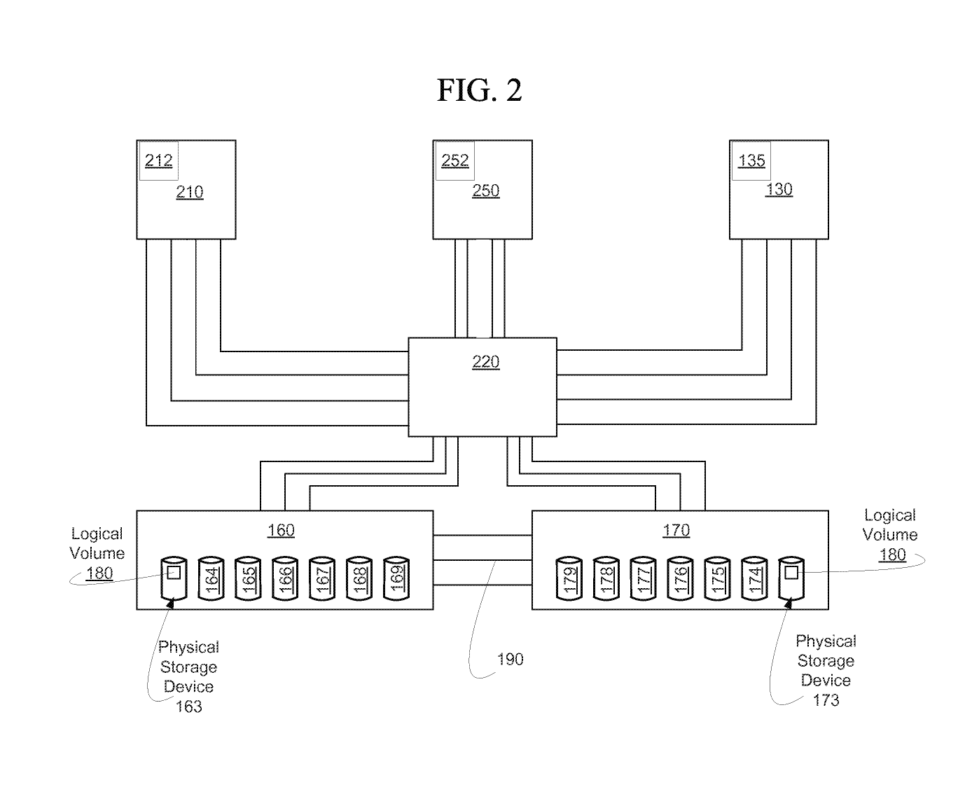

Referring to FIG. 2, Applicant's MoneyPool server 130 is communicatively connected to storage controller 220. In certain embodiments, Applicant's MoneyPool server 130 is integral with storage controller 220. In the illustrated embodiment of FIG. 2, MoneyPool servers 210 and 250 are also in communication with storage controller 220. In the illustrated embodiment of FIG. 2, three different MoneyPool servers are all in communication with storage controller 220. In certain embodiments, Applicant's MoneyPool Network 100 comprises more than three different MoneyPool servers in the network.

Further in the illustrated embodiment of FIG. 2, Applicant's MoneyPool server 130 comprises Permissions File 135, and MoneyPool servers 210 and 250 comprise Permissions Files 212 and 252, respectively.

In the illustrated embodiment of FIG. 2, storage controller 220 is in communication with data storage library 160 and/or 170. Each of the data storage libraries 160 and 170 have corresponding physical storage devices, such as and without limitation physical data storage devices 163-169 for data storage library 160; and 173-179 for data storage library 170.

In certain embodiments, physical data storage devices 163-169 and 173-179, comprise one or more hard disk drives, tape cartridge libraries, optical disks, combinations thereof, and/or any suitable data storage medium, storing one or more databases, or the components thereof, in a single location or in multiple locations, or as an array such as a Direct Access Storage Device (DASD), redundant array of independent disks (RAID), virtualization device, and the like. In certain embodiments, information encoded in these physical data storage devices is structured using a database model, such as a relational model, a hierarchical model, a network model, an entity-relationship model, an object-oriented model, or a combination thereof.

In certain embodiments, data storage library 160 and data storage library 170 are configured in a Peer To Peer Remote Copy (“PPRC”) storage system, wherein the information fields in data storage library 160 is automatically backed up in data storage library 170. In certain embodiments, Applicant's PPRC storage system utilizes synchronous copying. In certain embodiments, Applicant's PPRC storage system utilizes asynchronous copying.

In certain embodiments, each physical storage device in data storage library 160 is configured to comprise a plurality of logical volumes. Similarly, each physical storage device in data storage library 170 is configured to comprise a corresponding plurality of logical volumes. In the illustrated embodiment of FIG. 2, physical storage device 163 is configured to comprise logical volume 180. In certain embodiments, Permissions Files 135, 212, and/or 252 associates each logical volume with a unique MoneyPool Access Code, and further associates each logical volume with access permissions for each MONEYPOOL Participant.

A MONEYPOOL Participant can update their information in an associated unique profile. MoneyPool administrators can access that updated information seamlessly through Applicant's MoneyPool algorithm 136.

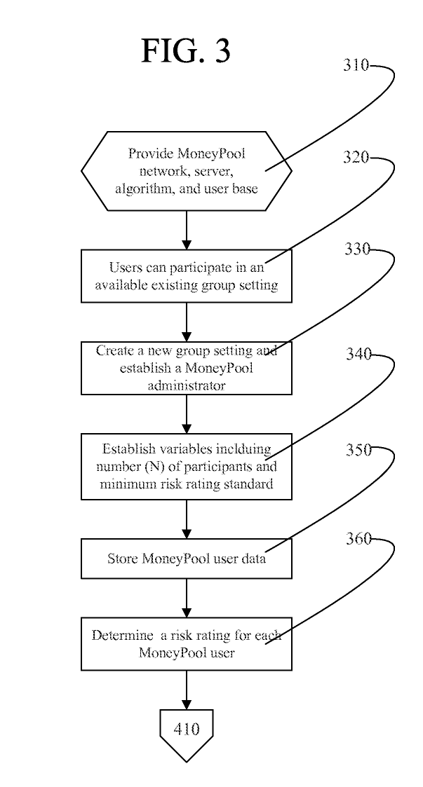

FIG. 3 summarizes certain initial steps in Applicant's method. Referring now to FIG. 3, in step 310 the method provides a MoneyPool network, such as and without limitation MoneyPool network 100. The method further provides in step 310 a MoneyPool server, such as and without limitation MoneyPool server 130. The method further provides in step 310 a MoneyPool algorithm, such as and without limitation MoneyPool algorithm 136.

In certain embodiments, in step 320 the public will be notified of the availability to access the network 100 and participate in an existing group setting that is not yet closed. In certain embodiments, such notification can be accomplished by television media, print media, word of mouth or any other reasonable means of informing people that a new group setting is available for participation. In this embodiments, the public can access the network 100 and form peer-selected groups of any plurality to directly participate in an available group setting.

In step 330, an existing MoneyPool user establishes a new and unique MoneyPool group setting, thus becoming a MoneyPool group setting administrator for the newly-created group setting. In certain embodiments, step 330 is performed by accessing and using MoneyPool algorithm 136.

In step 340, the new group setting administrator of step 330 establishes variables for the new group setting which make the new group setting unique. In certain embodiments, step 340 is performed by MoneyPool algorithm 136.

In certain embodiments, the variables include a number (N) of participants in the new group setting, a contribution amount, a disbursement amount, a length of interval, number of intervals, and minimum risk rating standards.

in step 350, the method stores data for each MoneyPool user. In certain embodiments, the data unique to each MoneyPool user includes that user's MoneyPool history. In certain embodiments, each MoneyPool user is assigned a unique logical volume configured on, for example and without limitation, data storage library 160. In certain embodiments, step 350 is performed by MoneyPool algorithm 136.

In step 360, the method determines a risk rating for each MoneyPool user. In certain embodiments, step 360 is performed by MoneyPool algorithm 136.

In certain embodiments, a credit history and credit rating generated by an established credit rating agency is included in each MoneyPool user's data. As those skilled in the art will appreciate, a credit bureau or consumer reporting agency, or credit reference agency is a company that collects information from various sources and provides consumer credit information on individual consumers for a variety of uses. Such credit bureaus are organizations providing information on individuals' borrowing and bill-paying habits.

In certain embodiments, the data entered for each MoneyPool user, include credit rating obtained from a credit bureau, are used to generate that user's unique proprietary risk rating. In certain embodiments of Applicant's method, the risk rating established for all MoneyPool users can be accessed by any individual MoneyPool user via a computing device 130/150 comprising Applicant's API and a unique MoneyPool Access Code.

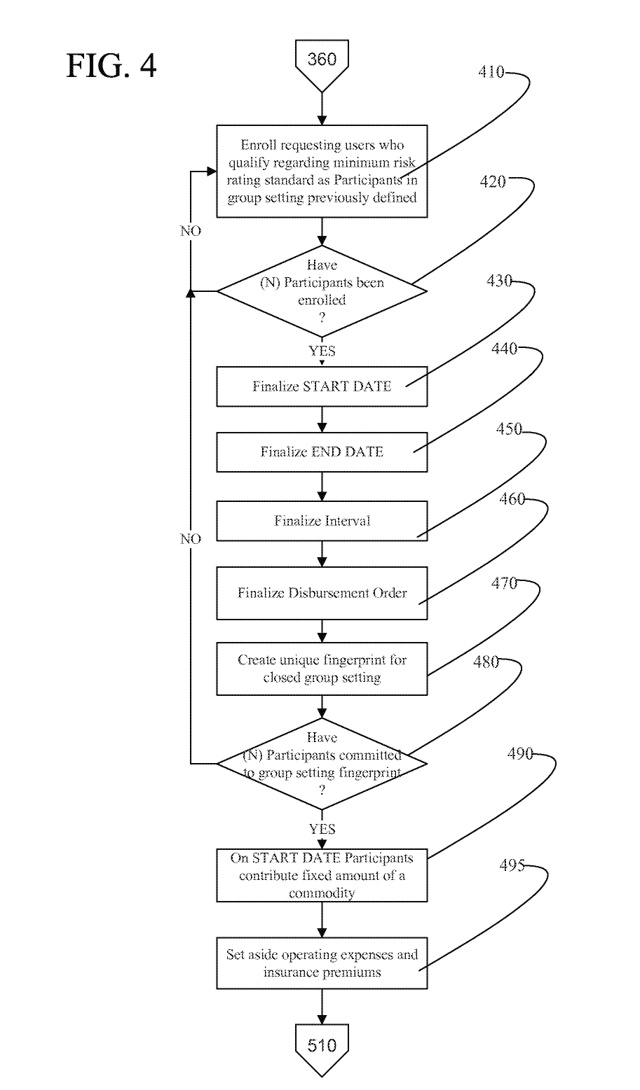

Individual MoneyPool users can request to join the new group setting of step 320. Referring now to FIG. 4, in step 410 the method enrolls requesting users as MoneyPool Participants if those requesting users qualify to join the new group setting by virtue of meeting the minimum risk rating for that new group setting established in step 340. In certain embodiments, step 410 is performed by MoneyPool algorithm 136.

In certain embodiments, other MoneyPool users can determine the MoneyPool Participants enrolled in the new group setting, and the ability to review the proprietary risk ratings of those enrolled MoneyPool Participants will assist MoneyPool users to evaluate the associated risk of joining the peer-selected, new group setting. Each new MoneyPool Participants is encouraged to achieve and maintain a positive risk rating in order to represent a low risk to other MoneyPool Participants.

In step 420, the method determines if (N) Participants have been enrolled in the new group setting. In certain embodiments, step 420 is performed by MoneyPool algorithm 136.

If the method determines in step 420 that (N) Participants have not yet been enrolled, then the method transitions from step 420 to step 410 and continues as described herein. Alternatively, if the method determines in step 420 that (N) Participants have been enrolled, then the method transitions from step 420 to steps 430, 440, and 450, wherein the method finalizes a state date, end date, and an interval length, for the group setting of step 320.

In step 460, the method finalizes a disbursement order. In certain embodiments, the disbursement order is decided by mutual agreement of the Participants. In certain embodiments, the disbursement order is decided by lottery. In certain embodiments, the disbursement order is decided by risk ratings of the Participants, wherein the Participant with the lowest risk rating receives a first disbursement and the Participant with the highest risk rating receives a final disbursement, with the remaining intermediate disbursement being made based upon the then-current risk ratings of the Participants.

In step 470, the method creates a group setting fingerprint which includes the determinations made in steps 430, 440, 450, and 460. In certain embodiments, step 470 is performed by MoneyPool algorithm 136.

In certain embodiments, the unique group setting fingerprint of step 430 will be used to keep track of the method variables, such as and without limitation group setting Participants, interval contribution, start/stop date, disbursement amount, number and length of intervals and disbursement order.

In step 480, the enrolled group setting Participants of step 410 are asked to commit to the fingerprint of step 470 thereby locking them into a commitment for the period between the start and stop dates of steps 430 and 440.

In step 490, the enrolled Participants of step 410 will each contribute a fixed amount of a commodity. In certain embodiments, the commodity comprises a currency, such as and without limitation the US Dollar, Canadian Dollar, Euro, and the like. In certain embodiments, the commodity comprises a fixed weight and/or a fixed value of a precious metal, such as and without limitation gold, silver, platinum, and the like. In certain embodiments, the commodity comprises a fixed weight and/or value of diamonds, rubies, or other precious gems.

In certain embodiments, wherein the commodity comprises a currency, the contributions of step 490 are automatically made by a pre-authorized withdrawal from a designated account. In certain embodiments, step 490 is performed by MoneyPool algorithm 136.

In step 495, the method sets aside from the contributions of step 490, assets needed to cover business/operating expenses, insurance premiums, and the like. The insurance premiums are paid to obtain insurance to cover any subsequent contribution defaults made by enrolled Participants. This insurance can either be an outside third party company, an in-house self insured variation or another user within the network.

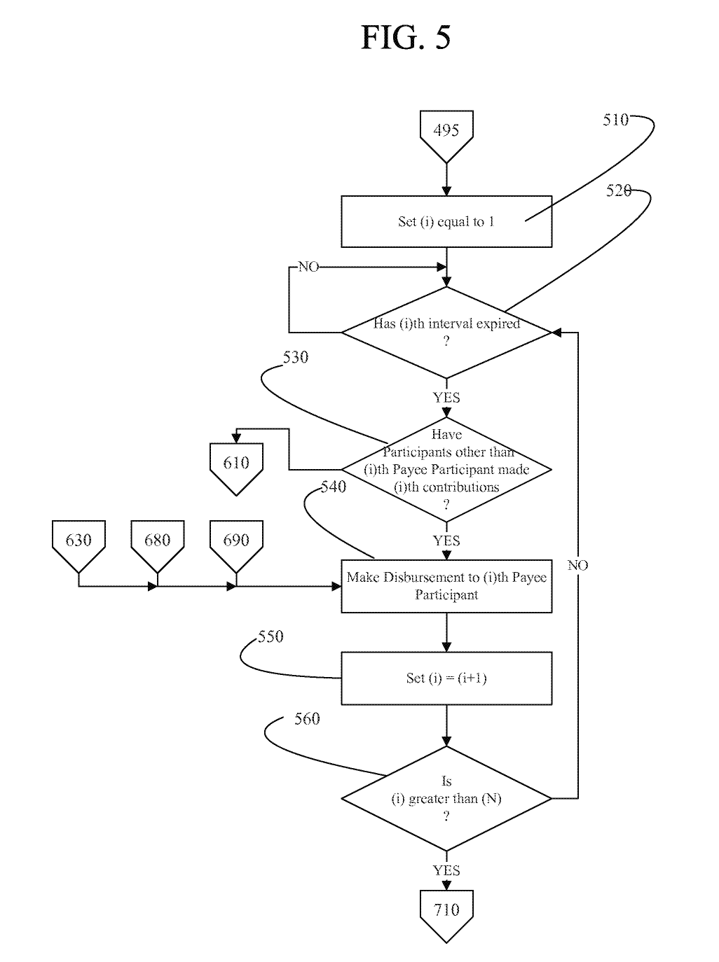

Referring now to FIG. 5, in step 510 the method sets a variable (i) to 1. In certain embodiments, step 510 is performed by MoneyPool algorithm 136.

In step 520, the method determines if an (i)th interval has expired. In certain embodiments, step 520 is performed by MoneyPool algorithm 136. If the method determines in step 520 that an (i)th interval has not expired, then the method continues monitoring whether the (i) interval has expired.

Alternatively, if the (i)th interval has expired, then the method transitions from step 520 to step 530 wherein the method determines if all the Participants, other than the (i)th Payee Participant, made the (i)th contribution. In certain embodiments, step 530 is performed by MoneyPool algorithm 136.

If the method determines in step 530 that all Participants, except the (i)th Payee participant, made an (i)th contribution, then the method transitions from step 530 to 540 wherein the method makes an (i)th disbursement to a designed (i)th Payee Participant. If all required contributions are collected on schedule, a positive mark will be reported to the credit reporting agencies, such as and without limitation Experian, Equifax, Transunion or any other acceptable third party credit bureau, on the Participant's behalf.

If the method determines in step 530 that not all Participants made an (i)th contribution, then the method transitions from step 530 to step 610 wherein the method holds disbursement of an (i)th disbursement to a designed (i)th Payee Participant. In certain embodiments, step 610 is performed by MoneyPool algorithm 136.

In step 620, the method makes repeated attempts to collect any delinquent contributions during a pre-defined grace period. In certain embodiments, step 620 is performed by MoneyPool algorithm 136.

In step 630, the method determines if a delinquent contribution has been made. In certain embodiments, step 630 is performed by MoneyPool algorithm 136. If the method determines in step 630 that a delinquent contribution has been made, then the method transitions to step 540.

If the method determines in step 630 that a delinquent contribution has not been made, then the method transitions from step 630 to step 640 wherein the method determines if the grace period has expired. In certain embodiments, step 640 is performed by MoneyPool algorithm 136.

If the method determines in step 640 that the grace period has not expired, then the method transitions to step 620 and continues as described herein. Alternatively, if the method determines in step 640 that the grace period has expired, then the method transitions from step 640 to step 650 wherein the method utilizes insurance funds to make the delinquent payment. In certain embodiments, step 650 is performed by MoneyPool algorithm 136. Further in step 650, the delinquent Participant will have a negative mark reported to the credit reporting agencies.

In step 660, the method removes the delinquent Participant from the group setting. In certain embodiments, step 660 is performed by MoneyPool algorithm 136.

In step 670, the method determines if the removed Participant has made a penalty payment. In certain embodiments, step 670 is performed by MoneyPool algorithm 136. If the method determines that a penalty payment has not been made, then the method sets (N) equal to (N−1) in step 680. In certain embodiments, step 680 is performed by MoneyPool algorithm 136. The method transitions from step 680 to step 540 (FIG. 5).

If the method determines in step 670 that a penalty payment has been made, then in step 690 the method reinstatement the delinquent Participant. In certain embodiments, step 690 is performed by MoneyPool algorithm 136. The method transitions from step 690 to step 540.

Referring once again to FIG. 5, in step 540 the method make an (i)th disbursement to an (i)th Payee Participant. The (i)th Payee Participant is determined using the disbursement order of step 460. In certain embodiments, step 670 is performed by MoneyPool algorithm 136.

As a general matter, the enrolled Participants take turns at each interval receiving the full collected contribution until all users have received their lump sum, also known as the disbursement. Depending on the interval in which a Participant receives his/hers/its disbursement, the Participants alternate between being lenders and borrowers.

In step 550, the method increments (i), i.e. sets (i) equal to (i+1). In step 560, the method determines if (i) is greater than (N). In certain embodiments, step 550 is performed by MoneyPool algorithm 136. If (i) is not greater than (N), then the method transitions from step 560 to step 520 and proceeds as described herein.

If (i) is greater than (N), then all disbursements have been made, and the stop date has been reached, and the method transitions from step 650 to step 710.

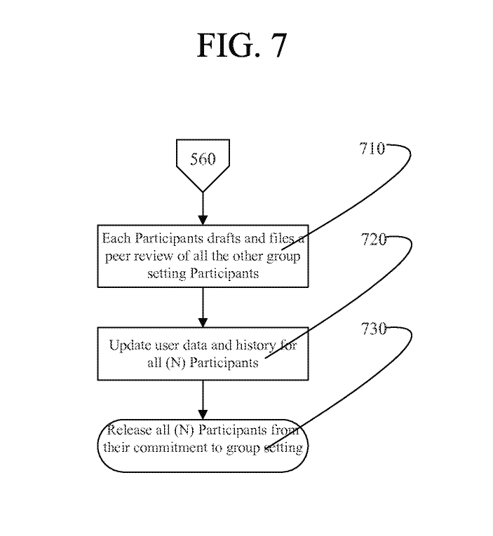

Referring now to FIG. 7, the method transitions from step 560 to step 710. In step 710 and after the last contributions were made and after the final disbursements have been made, each Participant drafts and files a peer review of the other group setting Participants.

In step 720, the method updates user data for all Participants showing their payment and disbursement histories. In certain embodiments, step 550 is performed by MoneyPool algorithm 136.

In step 730, the method releases all (N) Participants from their commitment to the group setting of step 330. In certain embodiments, step 730 is performed by MoneyPool algorithm 136.

In certain embodiments, individual steps recited in FIG. 3 and/or FIG. 4, may be combined, eliminated, or reordered.

In certain embodiments, Applicant's invention includes instructions residing in memory, such as for example memory 134 (FIG. 1), 144 (FIG. 1), and 154 (FIG. 1), 212, 222, 232, 242, 252, 262, disposed in a device, such as device 132, 142, 152, 210, 220, 230, 240, 250, and 260, respectively, wherein those instructions are executed by a processor disposed in that device to perform one or more of steps 305, 310, 320, 330, 340, 350, 360, 370, 380, 390, and/or 395, recited in FIG. 3, and/or one or more of steps 410, 420, 430, 440, 450, 460, and/or 470, recited in FIG. 4.

In certain embodiments, Applicant's invention includes instructions residing in memory, such as for example shared memory 110 (FIGS. 1, 2), wherein those instructions are executed by a processor disposed in a management module, such as management module 120, to perform one or more of steps 510, 520, 530, 540, 550, 560, 570, 580, 590, and/or 595, recited in FIG. 5.

In other embodiments, Applicant's invention includes instructions residing in any other computer program product, where those instructions are executed by a computer external to, or internal to, system 100, to perform one or more of steps 305, 310, 320, 330, 340, 350, 360, 370, 380, 390, and/or 395, recited in FIG. 3, and/or one or more of steps 410, 420, 430, 440, 450, 460, and/or 470, recited in FIG. 4, and/or one or more of steps 510, 520, 530, 540, 550, 560, 570, 580, 590, and/or 595, recited in FIG. 5. In either case, the instructions may be encoded in an information storage medium comprising, for example, a magnetic information storage medium, an optical information storage medium, an electronic information storage medium, and the like. By “electronic storage media,” Applicant means, for example and without limitation, one or more devices, such as and without limitation, a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth herein.

I claim:

1. A method to facilitate credit and savings, comprising:
establishing a group setting;
establishing an administrator for said group setting;
establishing variables for said group setting, wherein said variables include a risk ranking standard and a number (N) of participants, wherein (N) is greater than 3;
wherein said risk ranking comprises a credit rating determined by a credit bureau.

2. The method of claim 1, further comprising:
enrolling (N) participants, wherein each of said (N) participants has been assigned by a credit rating by a credit bureau exceeding said risk ranking standard;
creating a fingerprint for said group setting, wherein said fingerprint comprises a start date, an end date, a contribution amount, a disbursement amount, an interval, and a disbursement order, for said group setting;
committing by each of said (N) participants to said fingerprint.

3. The method of claim 2, further comprising:
on said start date, contributing a fixed amount of a commodity by each (N) participants;
setting aside insurance premiums and operating expenses from said (N) contributions.

4. The method of claim 3, further comprising:
initially setting (i) to 1;
determining if an (i)th interval has expired, wherein said disbursement order designates an (i)th payee participant;
if said (i)th interval has expired, determining if each of said (N) participants, except said payee participant, has made an (i)th contribution;
if each of said (N) participants, except said payee participant, has made an (i)th contribution, making an (i)th disbursement to said (i)th payee participant.

5. The method of claim 4, further comprising:
if each of said (N) participants, except said payee participant, has not made an (i)th contribution, during a pre-defined grace period attempting to collect a delinquent contribution;
if during said grace period, said delinquent contribution is made, making said (i)th disbursement to said (i)th payee participant.

6. The method of claim 5, further comprising if during said grace period, said delinquent contribution is not made, using insurance funds to make said delinquent contribution and making said (i)th disbursement to said (i)th payee participant.

7. The method of claim 6, further comprising:
incrementing (i) to equal (i+1);
determining if (i) is greater than (N);
if (i) is greater than (N), releasing all (N) participants from their commitment to said group setting.

8. An article of manufacture comprising a non-transitory computer readable medium having computer readable program code disposed therein to administer a money pool, the computer readable program code comprising a series of computer readable program steps to effect:
establishing a group setting;
establishing an administrator for said group setting;
establishing variables for said group setting, wherein said variable include a risk ranking standard and a number (N) of participants, wherein (N) is greater than 3;
wherein said risk ranking comprises a credit rating established by a credit bureau.

9. The article of manufacture of claim 8, the computer readable program code further comprising a series of computer readable program steps to effect:
enrolling (N) participants, wherein each of said (N) participants is assigned a credit rating by a credit bureau exceeding said risk ranking standard;
creating a fingerprint for said group setting, wherein said fingerprint comprises a start date, an end date, a contribution amount, a disbursement amount, an interval, and a disbursement order, for said group setting;
receiving a commitment from each of said (N) participants to said fingerprint.

10. The article of manufacture of claim 9, the computer readable program code further comprising a series of computer readable program steps to effect:
on said start date, receiving a fixed amount of a commodity by each of said (N) participants;
setting aside insurance premiums and operating expenses from said (N) contributions.

11. The article of manufacture of claim 10, the computer readable program code further comprising a series of computer readable program steps to effect:
initially setting (i) to 1;
determining if an (i)th interval has expired, wherein said disbursement order designates an (i)th payee participant;
if said (i)th interval has expired, determining if each of said (N) participants, except said payee participant, has made an (i)th contribution;
if each of said (N) participants, except said payee participant, has made an (i)th contribution, making an (i)th disbursement to said (i)th payee participant.

12. The article of manufacture of claim 11, the computer readable program code further comprising a series of computer readable program steps to effect:
if each of said (N) participants, except said (i)th payee participant, has not made an (i)th contribution, during a pre-defined grace period attempting to collect a delinquent contribution;
if during said grace period, said delinquent contribution is made, making said (i)th disbursement to said (i)th payee participant.

13. The article of manufacture of claim 12, the computer readable program code further comprising a series of computer readable program steps to effect if during said grace period, said delinquent contribution is not made, using insurance funds to make said delinquent contribution and making said (i)th disbursement to said (i)th payee participant.

14. The article of manufacture of claim 13, the computer readable program code further comprising a series of computer readable program steps to effect:
incrementing (i) to equal (i+1);
determining if (i) is greater than (N);
if (i) is greater than (N), providing a release to all (N) participants from their commitment to said group setting.

15. A computer program product encoded in a non-transitory information storage medium, wherein said computer program product is usable with a programmable computer processor to administer a money pool, comprising:
computer readable program code which causes said programmable computer processor to establish a group setting;
computer readable program code which causes said programmable computer processor to establish an administrator for said group setting;
computer readable program code which causes said programmable computer processor to establish variables for said group setting, wherein said variables include a risk ranking standard and a number (N) of participants, wherein:
(N) is greater than 3; and
said risk ranking comprises a credit rating obtained by from credit bureau.

16. The computer program product of claim 15, further comprising:
computer readable program code which causes said programmable computer processor to enroll (N) participants, wherein each of said (N) participants has been assigned a credit rating by a credit bureau exceeding said risk ranking standard;
computer readable program code which causes said programmable computer processor to create a fingerprint for said group setting, wherein said fingerprint comprises a start date, an end date, a contribution amount, a disbursement amount, an interval, and a disbursement order, for said group setting;
computer readable program code which causes said programmable computer processor to receive a commitment from each of said (N) participants to said fingerprint.

17. The computer program product of claim 16, further comprising:
computer readable program code which causes said programmable computer processor to on said start date, receive a contributing fixed amount of a commodity from each (N) participants;
computer readable program code which causes said programmable computer processor to set aside insurance premiums and operating expenses from said (N) contributions.

18. The computer program product of claim 17, further comprising:
computer readable program code which causes said programmable computer processor to initially set (i) to 1;
computer readable program code which causes said programmable computer processor to determine if an (i)th interval has expired, wherein said disbursement order designates an (i)th payee participant;
computer readable program code which, if said (i)th interval has expired, causes said programmable computer processor to determine if each of said (N) participants, except said payee participant, has made an (i)th contribution;
computer readable program code which, if each of said (N) participants, except said payee participant, has made an (i)th contribution, causes said programmable computer processor to make an (i)th disbursement to said (i)th payee participant.

19. The computer program product of claim 18, further comprising:
computer readable program code which, if each of said (N) participants, except said (i)th payee participant, has not made an (i)th contribution, causes said programmable computer processor to during a pre-defined grace period attempt to collect a delinquent contribution;
computer readable program code which, if during said grace period, said delinquent contribution is made, causes said programmable computer processor to make said (i)th disbursement to said (i)th payee participant.

20. The computer program product of claim 19, further comprising computer readable program code which, if during said grace period, said delinquent contribution is not made, causes said programmable computer processor to use insurance funds to make said delinquent contribution and make said (i)th disbursement to said (i)th payee participant.

21. The computer program product of claim 20, further comprising:
computer readable program code which causes said programmable computer processor to increment (i) to equal (i+1);
computer readable program code which causes said programmable computer processor to determine if (i) is greater than (N);
computer readable program code which, if (i) is greater than (N), causes said programmable computer processor to release all (N) participants from their commitment to said group setting.
